(19) United States
(12) Patent Application Publication
(10) Pub. No.: US 2014/0351065 A1
(43) Pub. Date: Nov. 27, 2014

(54) ENCODED GENRE IDENTIFYING DEVICE AND SYSTEM FOR PROMOTING OR SUPPORTING AN ENTITY IN THE GENRE

(71) Applicant: Fanatic Pass, LLC, Plantation, FL (US)

(72) Inventors: David DELIA, Plantation, FL (US); Leon CAMPBELL, Plantation, FL (US); Max ORELIUS, Plantation, FL (US)

(21) Appl. No.: 14/284,871

(22) Filed: May 22, 2014

Related U.S. Application Data
(60) Provisional application No. 61/826,126, filed on May 22, 2013.

(51) Int. Cl. G06F 17/30; G06Q 50/00; G06Q 30/02

(52) U.S. Cl. CPC G06F 17/30879; G06Q 30/0277; G06Q 50/01
USPC 705/14.72

(57) ABSTRACT

An encoded genre device and system having a substrate with indicia for identifying a particular genre entity, such as a sports team, band or charitable cause, and a machine readable or scannable code for providing access to a host website offering a plurality of badges/passes for various genre entities and, or access to the genre entity's website, a host website accessible through a computer network, a set of processor readable code for operating, managing and processing data related to genre entities, a set of processor readable code for data related to fans/customers and a set of processor readable code operating, managing and processing data related to the host website. The genre promotion device and system creates and manages memberships for fans registered with a genre or genre entity and provides discounts to fans that support a particular genre of genre entity.

### CROSS REFERENCE TO RELATED APPLICATIONS

This application claims the benefit of provisional patent application Ser. No. 61/280,237 filed Nov. 2, 2009.

### STATEMENT REGARDING FEDERALLY SPONSORED RESEARCH OR DEVELOPMENT

Not applicable.

### FIELD OF THE INVENTION

This invention relates generally to a genre promoting device and system, and more particularly, to an encoded badge having indicia on the badge and a machine readable code that, when scanned, identifies a particular entity within a specific genre and provides access to a host website offering badges and information for a plurality of genres and, or direct or indirect access to the entity's website.

### BACKGROUND OF THE INVENTION

A fanatic is defined as a person with extreme enthusiasm and often intense uncritical devotion. It is well known that fanatical people, i.e. fans, love to show their devotion to a particular sports team, performer, musical group, politician, political party or social cause, such as inter alia breast cancer, heart disease, homosexual rights and global warming, generally referenced herein as genres, with t-shirts, pins, bumper stickers and various signs. Websites are typically created to promote various entities within a genre, update the public on social gatherings, publish press releases and to raise money through the sale of merchandise, such as shirts, hats and bumper stickers. Unfortunately, these methods for promoting genres and entities in a genre are antiquated and in effective, especially given current technology and social media. They are merely point of sale and do not facilitate instant access to a genre's website or information, the ability to cross promote or the option to explore multiple genre's from a single location or website. Conventional methods and forums for fans also do not fully capture and are allow a fan to display and share their enthusiasm for a genre at anywhere, anytime and all the time.

Despite the advancements in technology and social media, they have not been fully realized in the world of fanatic enthusiasm. Current technology includes the use of bar codes, QR codes (quick response codes) and near-field communication (NFC) codes to store information for access through scanning. These scanning codes have yet to be used on badges or other mediums, such as bracelets or pendants, that store information for identifying and promoting a genre and providing access to the genre's website or a host website that offers the ability to gain access to a plurality of different genres. Social media includes Facebook®, Twitter®, YouTube® and Instagram®. If there existed an encoded genre identifying device and system for promoting or supporting an entity in a genre that also merged it with social media, it would streamline and enhance access to a variety of genres, more effectively promote and raise awareness for multiple genres and facilitate growth of entities within these genres.

However, there are no devices or systems known that take advantage of or even contemplate the use of modern scanning codes and social media for identifying, promoting and streamlining access to genres. Therefore, there exists a need for such a device and system. It is, therefore, to the effective resolution of the aforementioned problems and shortcomings of the prior art that the present invention is directed. The instant invention addresses this unfulfilled need in the prior art by providing an encoded genre identifying device and system for identifying, promoting and streamlining access to genres and entities in genres as contemplated by the instant invention disclosed herein.

### SUMMARY OF THE INVENTION

In accordance with one aspect, the present invention provides a genre promotion device and system for enabling participants to register with and support a particular genre, cause or client in a genre, such as a musical group, performer, sports team, country or a social cause, like breast cancer, world peace, heart disease or any particular organized cause, which are generally referenced herein as a genre or client/entity within a genre.

In another aspect, the present invention provides a genre promotion device and system that registers a fan, provides a device corresponding to a particular genre or genre entity, a scannable code on the device for accessing the genre's website or other information and continuously promotes the genre, drives traffic to the genre's website, and facilitates sales that raise revenue for the genre.

In an additional aspect, the present invention provides a genre promotion device and system for creating and managing memberships for fans registered with a genre or genre entity and, or provide discounts to fans that support a particular genre of genre entity.

In a further aspect, the present invention provides an encoded genre device and system having a badge or pass with a scannable code for accessing data related to a user's registration and at least one genre associated with the user's registration, a lanyard or other support structure for allowing the user to wear and display the pass and a set of processor readable code of instructions for operating, managing and processing the features of the instant invention.

In accordance with yet another aspect, the present invention includes an encoded genre device and system having a substrate with indicia for identifying a particular genre entity and a machine readable or scannable code for providing access to a host website offering a plurality of badges/passes for various genre entities and, or access to the genre entity's website, a host website accessible through a computer network, a set of processor readable code for operating, managing and processing data related to genre entities, a set of processor readable code for data related to fans/customers and a set of processor readable code operating, managing and processing data related to the host website.

In accordance with yet an additional aspect, the present invention includes an encoded genre device and system having a genre indicia and scannable code for each genre entity a set of processor readable code that is accessed when the code is scanned for providing access to a website page on the host website dedicated to the genre entity and access to a social media page of the genre entity.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

A more complete understanding of the present invention, and the attendant advantages and features thereof, will be more readily understood by reference to the following detailed description when considered in conjunction with the accompanying drawings wherein:

FIG. 1 is a front elevational view of the genre identifying badge of the encoded genre identifying and promoting device and system in accordance with the preferred embodiment of the instant invention.

FIG. 2 is a rear elevational view of the genre identifying badge of the genre identifying and promoting device and system showing the machine readable access code in accordance with the preferred embodiment of the instant invention.

FIG. 3 shows a flow diagram of the software logic for genres/clients/entities and fans/customers of the genre identifying and promoting device and system in accordance with the preferred embodiment of the instant invention.

FIG. 4 shows a customizable main page for genres/clients/entities of the genre identifying and promoting device and system in accordance with the preferred embodiment of the instant invention.

FIG. 5 shows a main page for fans/customers of the genre after scanning the code and shows linking to a plurality of media platforms in accordance with the preferred embodiment of the instant invention.

FIG. 6 shows an example of an official website page and layout for genres/clients/entities of the genre identifying and promoting device and system in accordance with the preferred embodiment of the instant invention.

FIG. 7 shows an example of an official Facebook® page for genres/clients/entities of the genre identifying and promoting device and system in accordance with the preferred embodiment of the instant invention.

FIG. 8 shows an example of an official Instagram® page for genres/clients/entities of the genre identifying and promoting device and system in accordance with the preferred embodiment of the instant invention.

FIG. 9 shows an example of an official Twitter® page for genres/clients/entities of the genre identifying and promoting device and system in accordance with the preferred embodiment of the instant invention.

FIG. 10 shows an example of a YouTube® page featuring all related broadcast about a genre/client/entity of the genre identifying and promoting device and system in accordance with the preferred embodiment of the instant invention.

FIG. 11 shows an example of a news links page associated with a featured genre/client/entity of the genre identifying and promoting device and system in accordance with the preferred embodiment of the instant invention.

FIG. 12 shows an example of a host or Fanatic Pass™ (Fanatic Pass™ is a trademark owned by Fanatic Pass, LLC) store front home website page of the genre identifying and promoting device and system in accordance with the preferred embodiment of the instant invention.

FIG. 13 shows an example of a host or Fanatic Pass™ (Fanatic Pass™ is a trademark owned by Fanatic Pass, LLC) catalog website page of the genre identifying and promoting device and system in accordance with the preferred embodiment of the instant invention.

FIG. 14 shows an example of a host or Fanatic Pass™ (Fanatic Pass™ is a trademark owned by Fanatic Pass, LLC) blog website page of the genre identifying and promoting device and system in accordance with the preferred embodiment of the instant invention.

FIG. 15 shows an example of a host or Fanatic Pass™ (Fanatic Pass™ is a trademark owned by Fanatic Pass, LLC) “About Us” website page of the genre identifying and promoting device and system in accordance with the preferred embodiment of the instant invention.

FIG. 16 shows an example of a host or Fanatic Pass™ (Fanatic Pass™ is a trademark owned by Fanatic Pass, LLC) products website page of the genre identifying and promoting device and system showing a small example of different products in accordance with the preferred embodiment of the instant invention.

FIG. 17 shows an example of a host or Fanatic Pass™ (Fanatic Pass™ is a trademark owned by Fanatic Pass, LLC) descriptive dialog website page featuring a selected product of the genre identifying and promoting device and system in accordance with the preferred embodiment of the instant invention.

FIG. 18 shows an example of a host or Fanatic Pass™ (Fanatic Pass™ is a trademark owned by Fanatic Pass, LLC) shopping cart website page of the genre identifying and promoting device and system in accordance with the preferred embodiment of the instant invention.

FIG. 19 shows an example of a host or Fanatic Pass™ (Fanatic Pass™ is a trademark owned by Fanatic Pass, LLC) customer payment and shipping website page of the genre identifying and promoting device and system in accordance with the preferred embodiment of the instant invention.

FIG. 20 shows an example of a host or Fanatic Pass™ (Fanatic Pass™ is a trademark owned by Fanatic Pass, LLC) customer/user's registration website page of the genre identifying and promoting device and system in accordance with the preferred embodiment of the instant invention.

FIG. 21 shows an example of a host or Fanatic Pass™ (Fanatic Pass™ is a trademark owned by Fanatic Pass, LLC) customer/user's profile website page of the genre identifying and promoting device and system which shows the badges purchased by the customer in accordance with the preferred embodiment of the instant invention.

FIG. 22 is a flow diagram of the logic for navigating through the program of the instant invention.

### DETAILED DESCRIPTION OF THE INVENTION

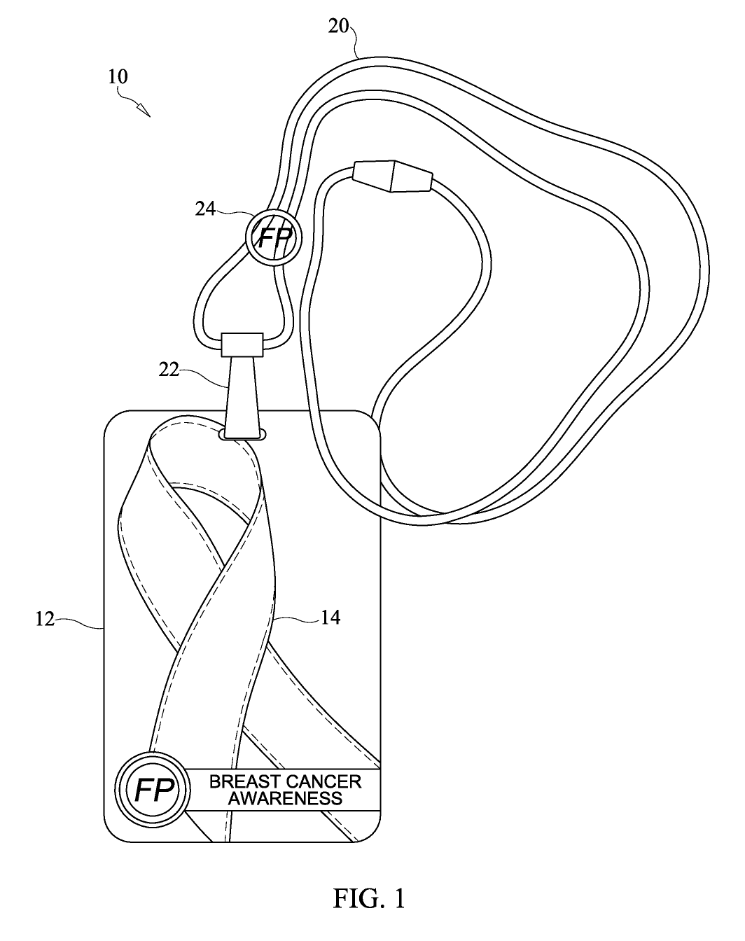

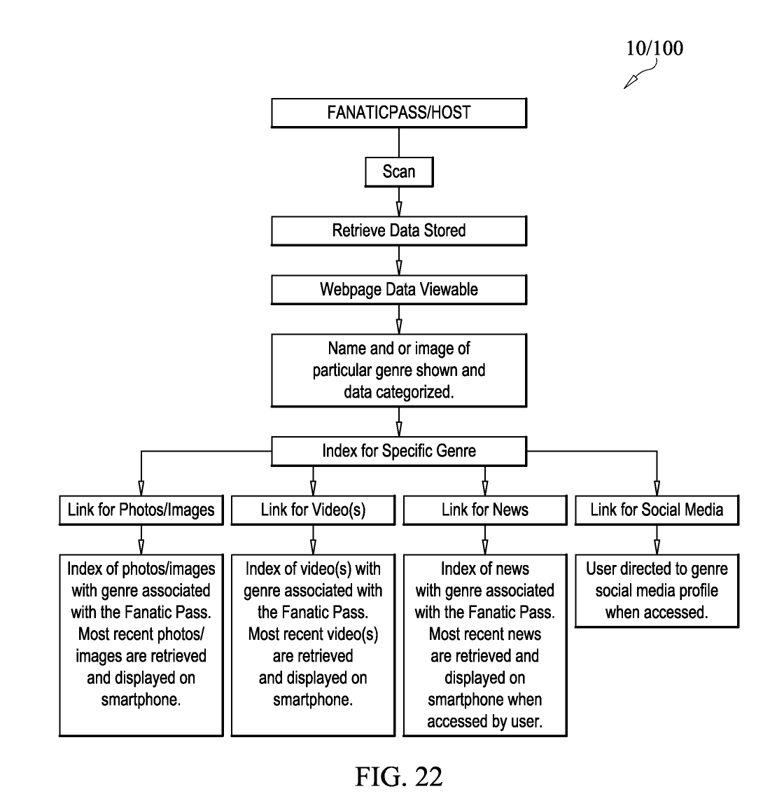

With reference to the drawings, FIGS. 1 to 22 depict the preferred embodiment of the instant invention which is generally referenced as an encoded genre promotion device or system and, or by numeric character 10. The genre promotion device and system 10 enables fans to show their support for a particular genre or client in a genre, such as a musical group, performer, sports team, country or social cause, such as breast cancer, world peace, heart disease or any particular organized cause, generally referenced herein as a genre or client/entity within a genre. These are just a few examples of what the instant invention 10 may be used to promote. The genre promotion device and system 10 captures the elements surrounding a fan's enthusiasm and serves a dual purpose. First, it enables and empowers a fan to visually and openly show and share their support for a particular genre or genre entity anywhere at any time, regardless of what they are wearing and with complete flexibility. Secondly, it promotes genres and genre entities or clients and drives traffic to their websites, venues and gatherings and facilitates the sale of merchandise or tickets or fundraising endeavors. In an alternative embodiment, the instant invention 10 can create and manage memberships for fans registered with a genre or genre entity and, or provide discounts to fans that support a particular genre of genre entity.

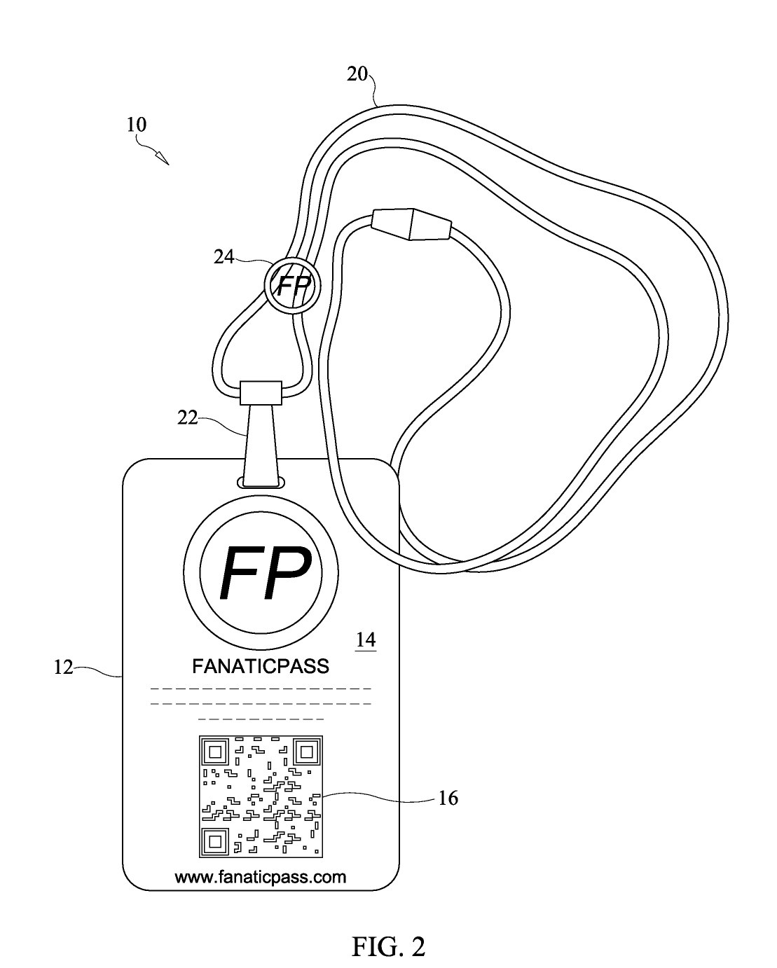

With reference to FIGS. 1-22, the encoded genre device and system 10 preferably comprises a badge or pass 12, a lanyard 20 or other support structure for allowing the fan/customer to wear and display the pass 12 and set of processor readable code of instructions 100, i.e. software for operating, managing and processing the features of the instant invention 10. With reference to FIGS. 1-2, the badge/pass 12 preferably comprises a substrate 12 having indicia 14 on a first surface and a machine readable or scannable code 16 on an opposite or second surface. The indicia 14 on the first surface identifies a particular genre or genre entity, such as breast cancer, as shown in FIG. 1, a musical group like the Foo Fighters®, a sports team like the Miami Dolphins™ or Miami Hurricanes™, or a country like the USA, just to name a few examples. The second surface may also comprise indicia, such as the company logo of the company to sells the badges and, or host a website for purchasing badges and possibly registering members, as illustrated by the Fanatic Pass™ indicia shown in FIG. 2. The machine readable or scannable code 16 preferably comprises a QR code, but may also comprise a bar code, NFC code or other code that could be read or scanned, generally referenced herein as genre code. When the code is scanned or read, it identifies a particular genre or genre entity and provides access to a host website offering a plurality of badges/passes for various genres or genre entities and, or direct or indirect access to the genre's or genre entity's website. The code 16 may also be used by the owner or customer to receive point of purchase discounts or purchases online at the badge host website or genre's website. The pass support device preferably comprises a lanyard 20 having a clip 22 for attaching to the pass 12 and adjustment ring 24 for adjusting the tension on the lanyard 20. Alternatively the pass 12 may comprise a bracelet, pendant or other article that could be worn by a fan and adapted for displaying a code for scanning or reading.

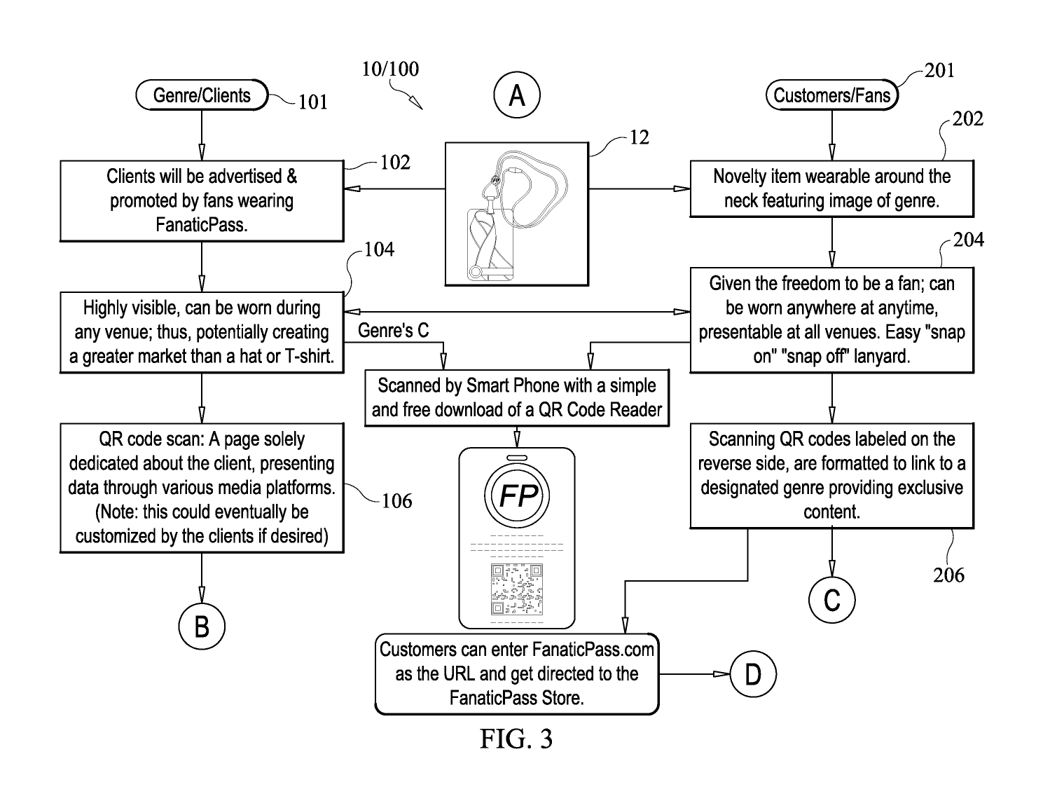

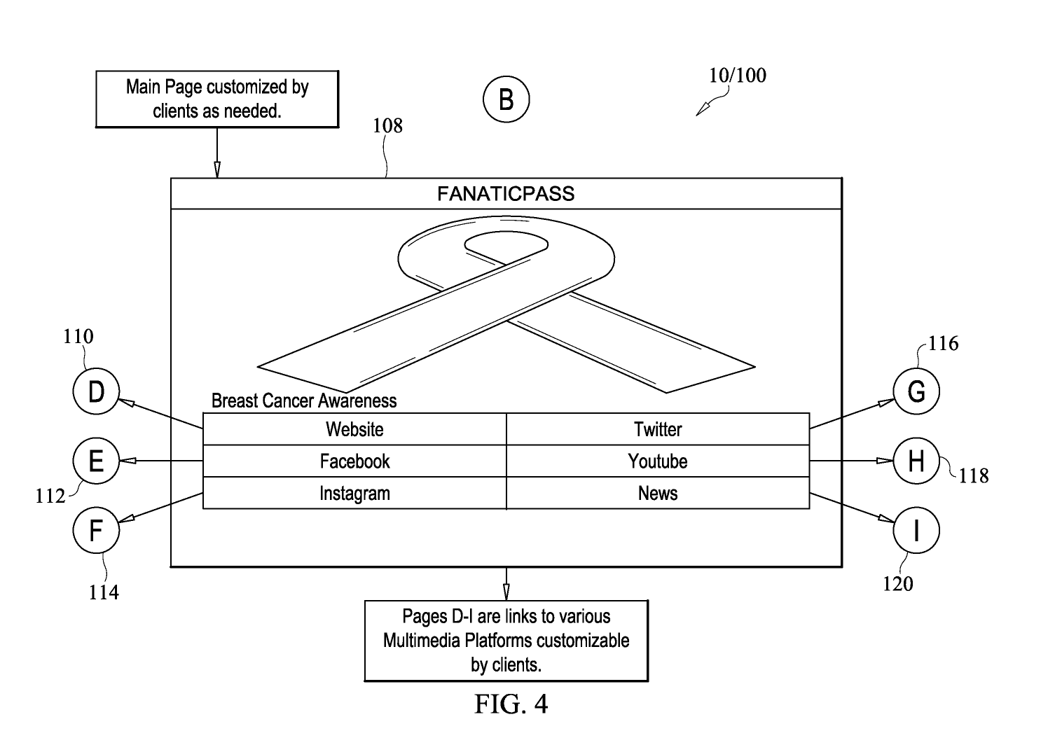

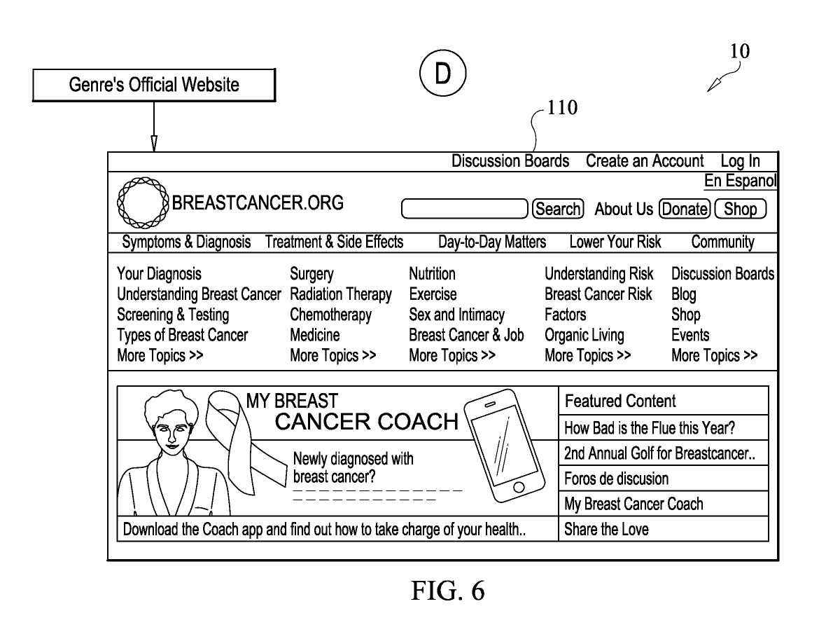

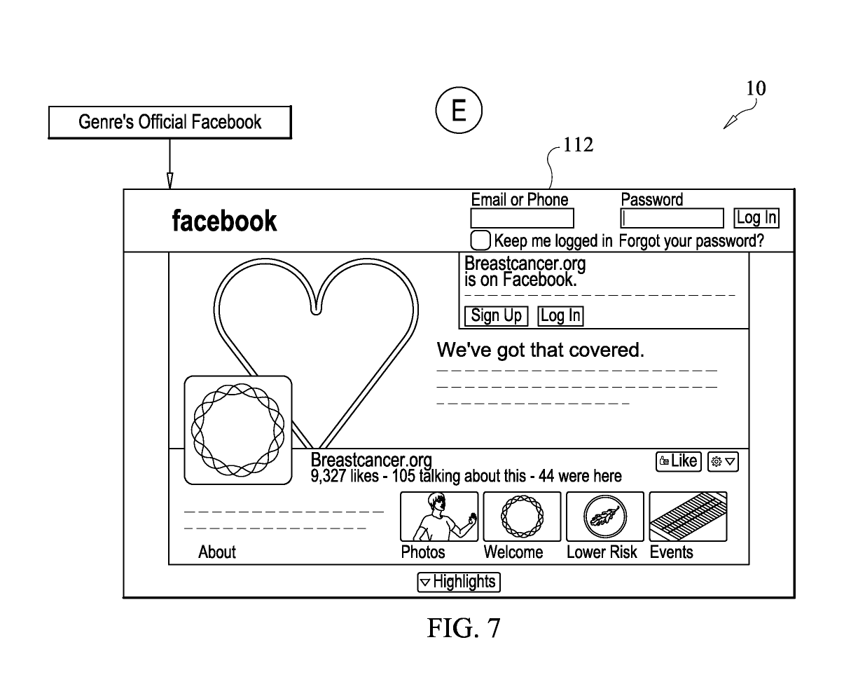

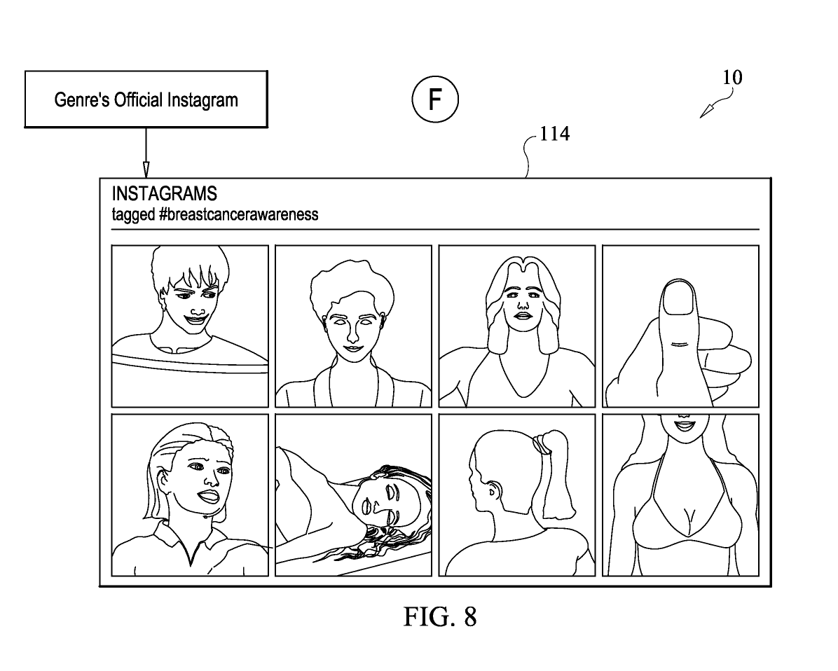

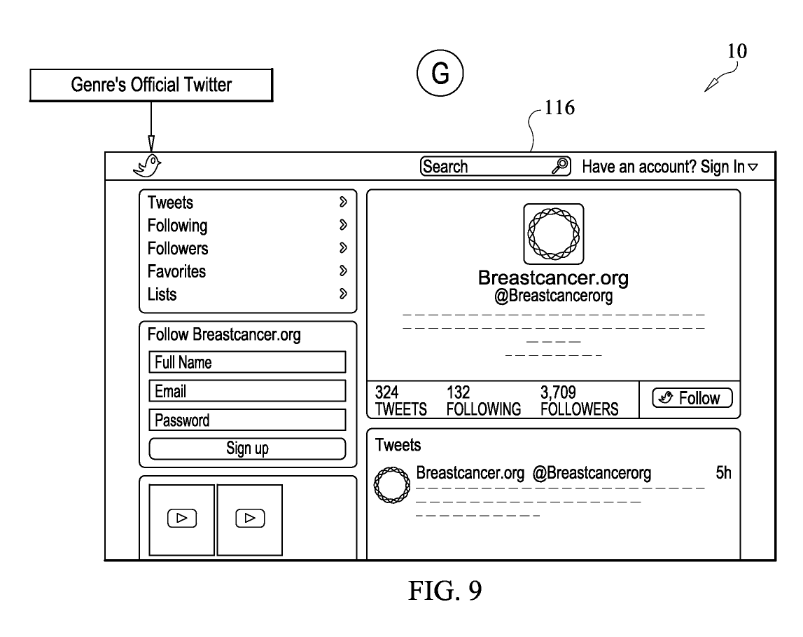

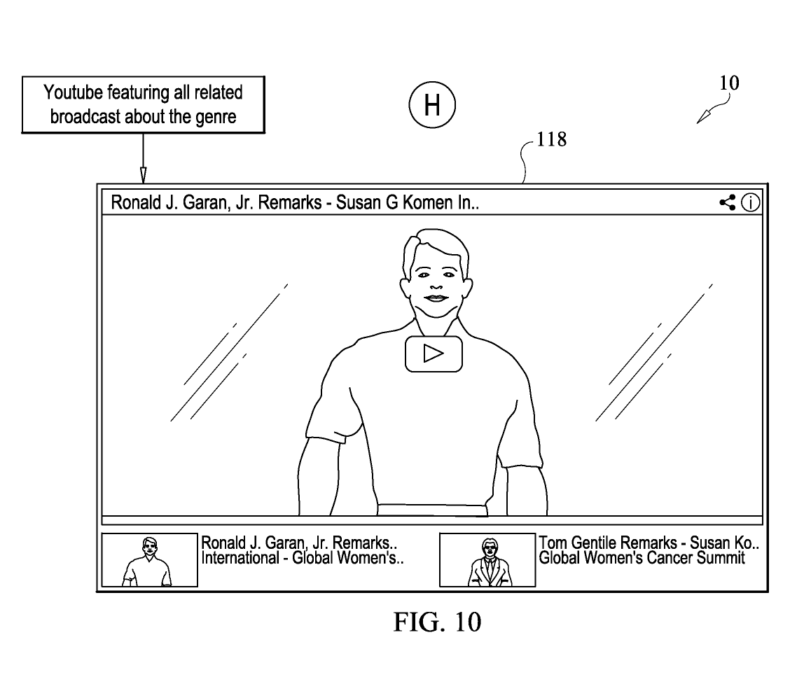

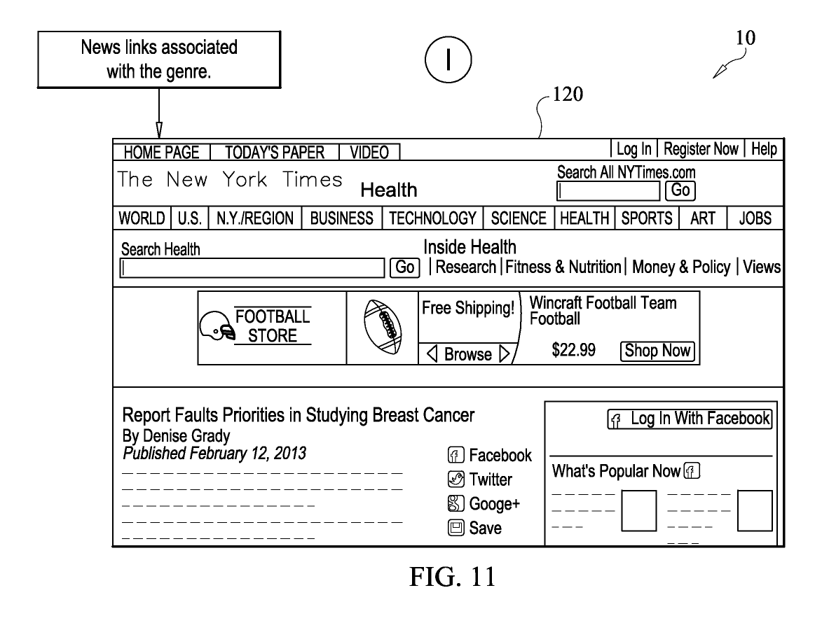

With reference to FIGS. 3-22, the genre promotion system 10 comprises software 100 for operating, managing and processing the instant invention 10. The software 100 comprises a set of processor readable code and screen displays 101-120 for genres and genre entities/clients (generally identified by numeral character 101), a set of processor readable code and screen displays 201-208 and 110-120 for fans/customers (generally identified by numeral character 201) and a set of processor readable code and screen displays 300-326 for the Fanatic Pass™ host and the host website and features. Referring to FIG. 3, in accordance with the genre/client code 101 genre clients are advertised and promoted when fans wear their pass 12 (102). The pass 12 (104) is highly visible and can be worn during any venue event or anywhere at any time to enhance and expand their market presence and potential. Research has shown that a highly visible, interactive badge or pass 12 can be much more effective in marketing a particular genre or genre client. When scanned, the genre code 16 identifies a genre in the system 10 and activates or provides access to a website page 108 on the Fanatic Pass™, or host, website, wherein this page 108 is solely dedicated to and about the genre client, presenting data through various media platforms. This page 108 may be customized by the genre client and could provide links to the genre client's website and, or other pages. Referring to FIG. 4, this page 108 preferably comprises links to social media and media outlets such as the genre Website 110, Facebook® 112, Instagram® 114, Twitter® 116, YouTube® 118 and News 120. With reference to FIG. 6, an example of a breast cancer awareness genre website page 110 is shown. Referring to FIG. 7, an example of the breast cancer awareness genre's Facebook® page 112 is shown. Referring to FIG. 8, an example of the breast cancer awareness genre's Instagram® page 114 is shown. Referring to FIG. 9, an example of the breast cancer awareness genre's Twitter® page 116 is shown. Referring to FIG. 10, an example of the breast cancer awareness genre's YouTube® page 118 is shown. Referring to FIG. 11, an example of the breast cancer awareness news release page 120 is shown.

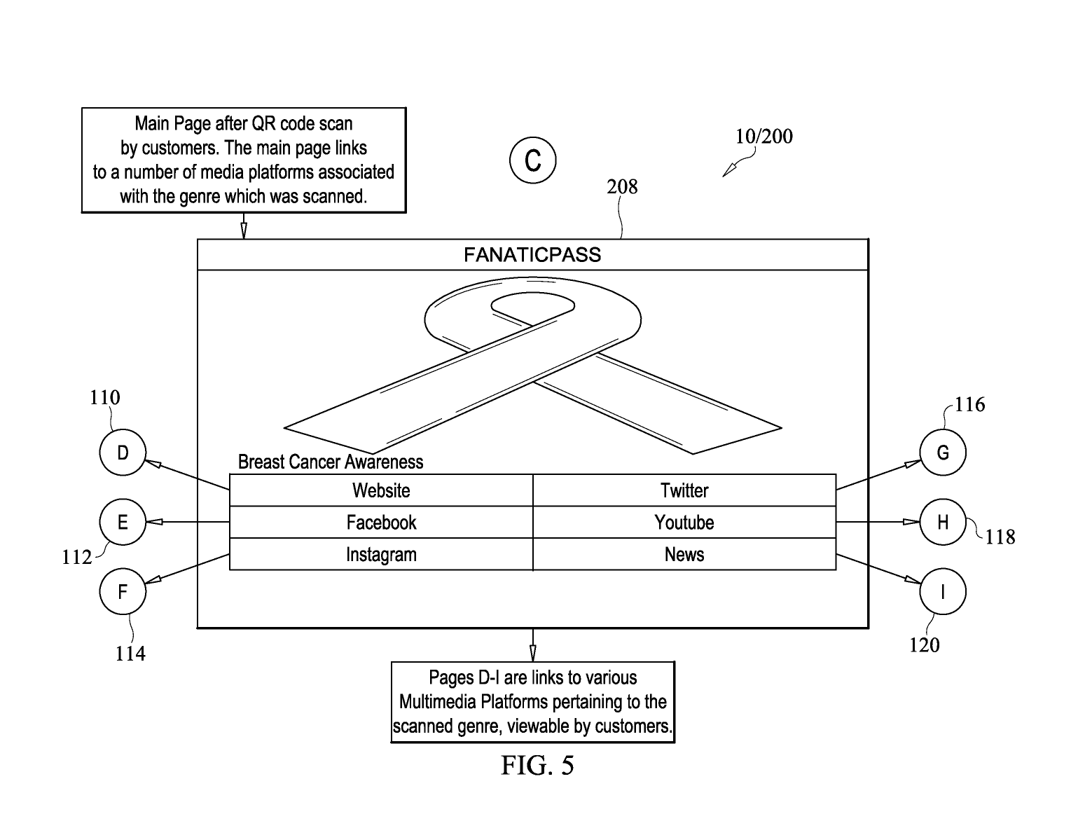

With reference to FIGS. 3 and 5-11, the set of processor readable code and screen displays 201-208 and 110-120 for fans/customers (generally identified by numeral character 201) are shown. Referring to FIG. 3, in accordance with the fan/customers code 201 (generally referenced as fans) fans purchase a badge/pass 12 and wear the pass 12 on their body using the lanyard 16 featuring the image of the genre (202). The fan can wear the pass 12 anywhere at any time and will be presentable all venues where the genre client appears and it is easily snapped on and off for changing the desired pass 12 (204). The pass 12 is highly visible and can be worn during any venue event or anywhere at any time to enhance and expand their market presence and potential. The genre code 16 is formatted such that when it is scanned or read it automatically links the fan to the genre on the Fanatic Pass™ website which provides exclusive content (206). When scanned, the genre code 16 identifies a genre in the system 10 and activates or provides access to a website page 208 on the Fanatic Pass™, or host, website, for the fan wherein this page 208 links to a number of social media or media platforms associated with the genre code that was scanned. Referring to FIG. 5, as with the genre client software 101, this page 208 preferably comprises links to social media and media outlets such as the genre Website 110, Facebook® 112, Instagram® 114, Twitter® 116, YouTube® 118 and News 120. With reference to FIG. 6, an example of a breast cancer awareness genre website page 110 is shown. Referring to FIG. 7, an example of the breast cancer awareness genre's Facebook® page 112 is shown. Referring to FIG. 8, an example of the breast cancer awareness genre's Instagram® page 114 is shown. Referring to FIG. 9, an example of the breast cancer awareness genre's Twitter® page 116 is shown. Referring to FIG. 10, an example of the breast cancer awareness genre's YouTube® page 118 is shown. Referring to FIG. 11, an example of the breast cancer awareness news release page 120 is shown.

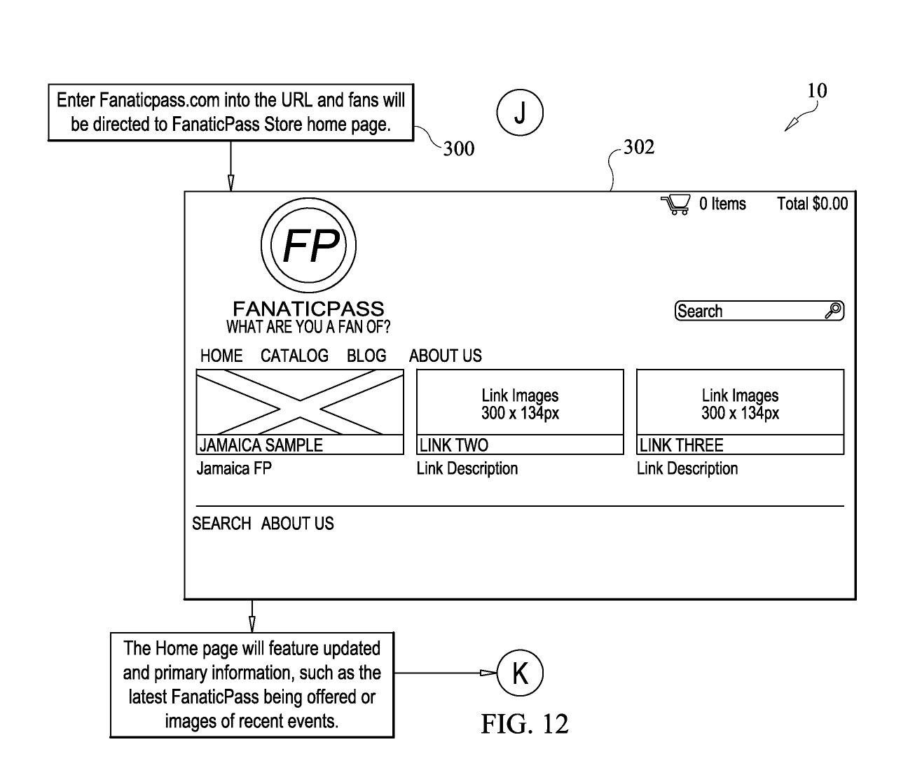

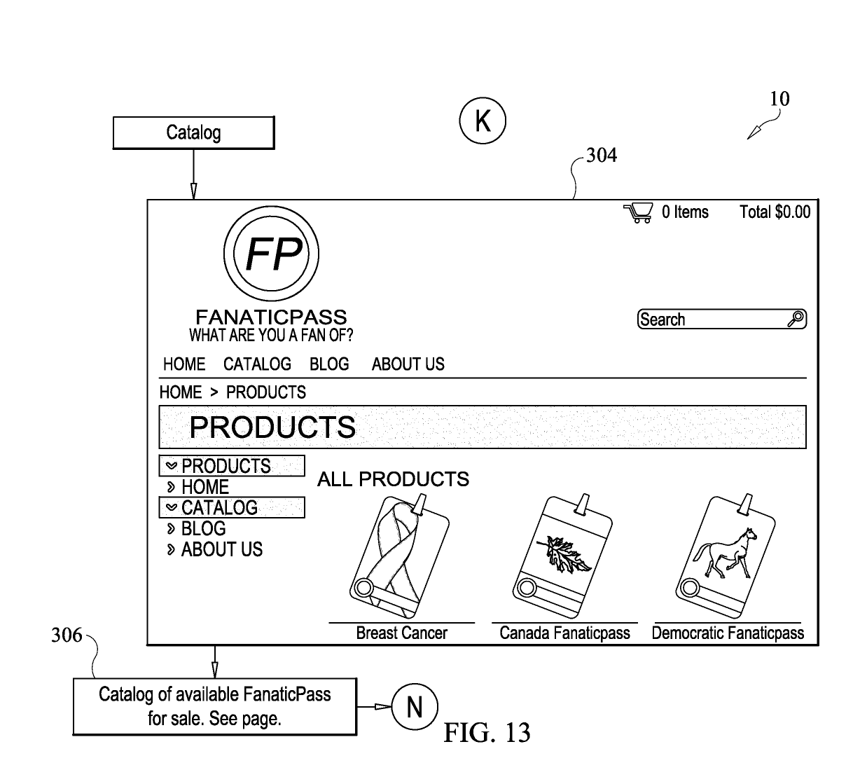

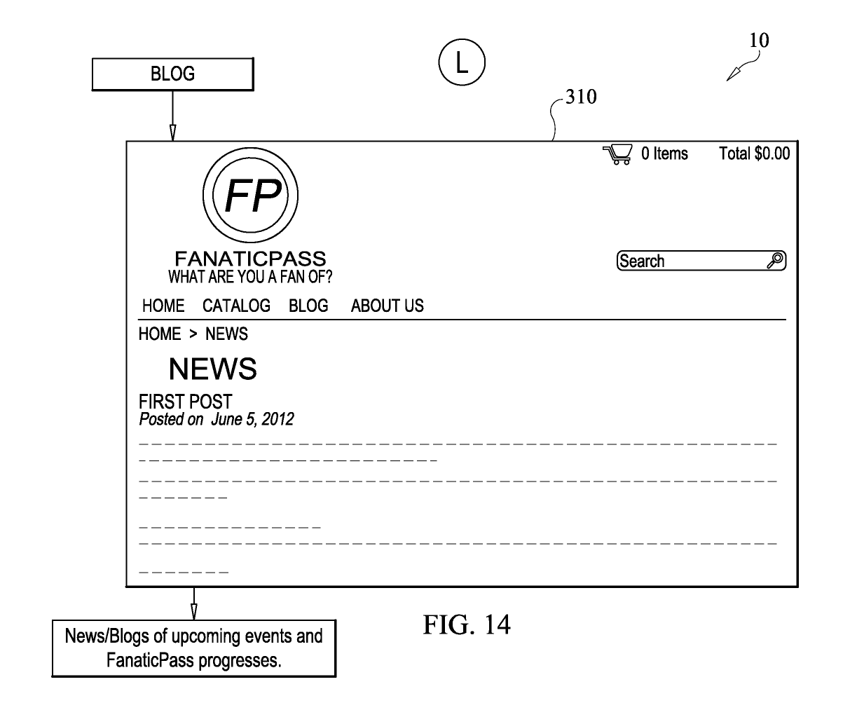

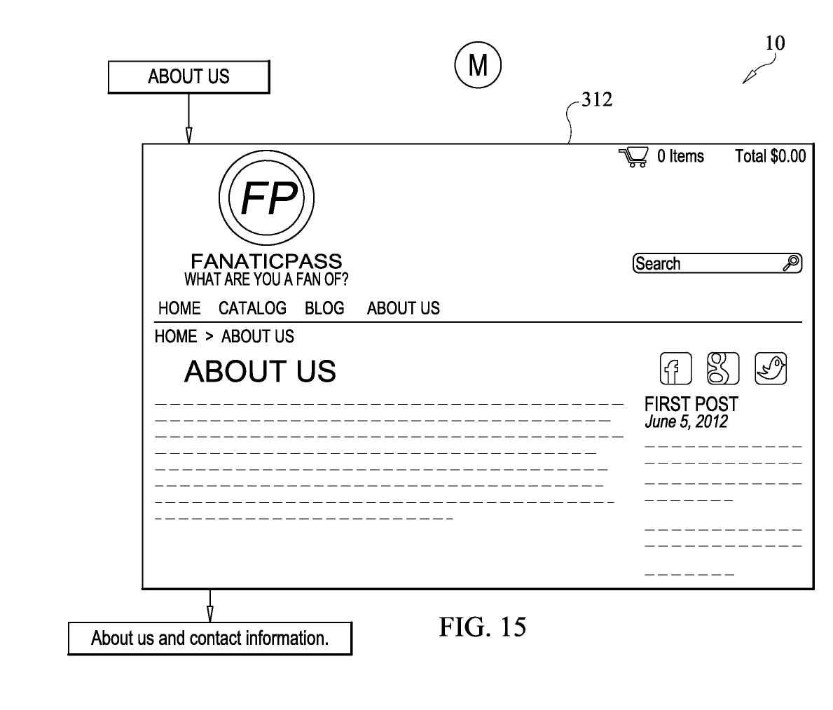

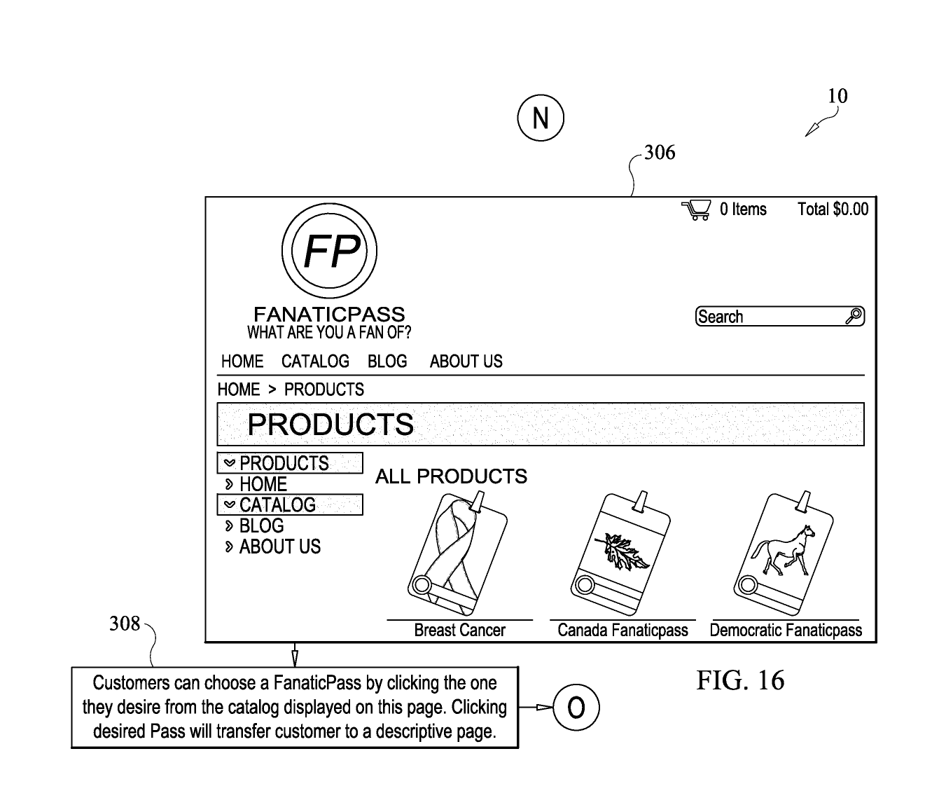

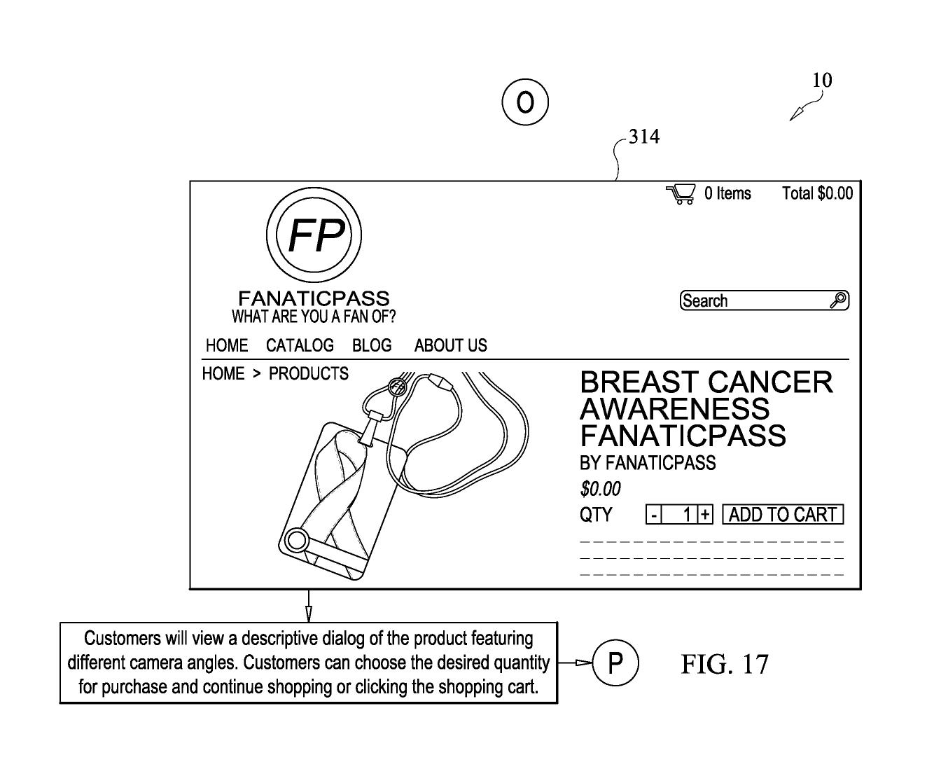

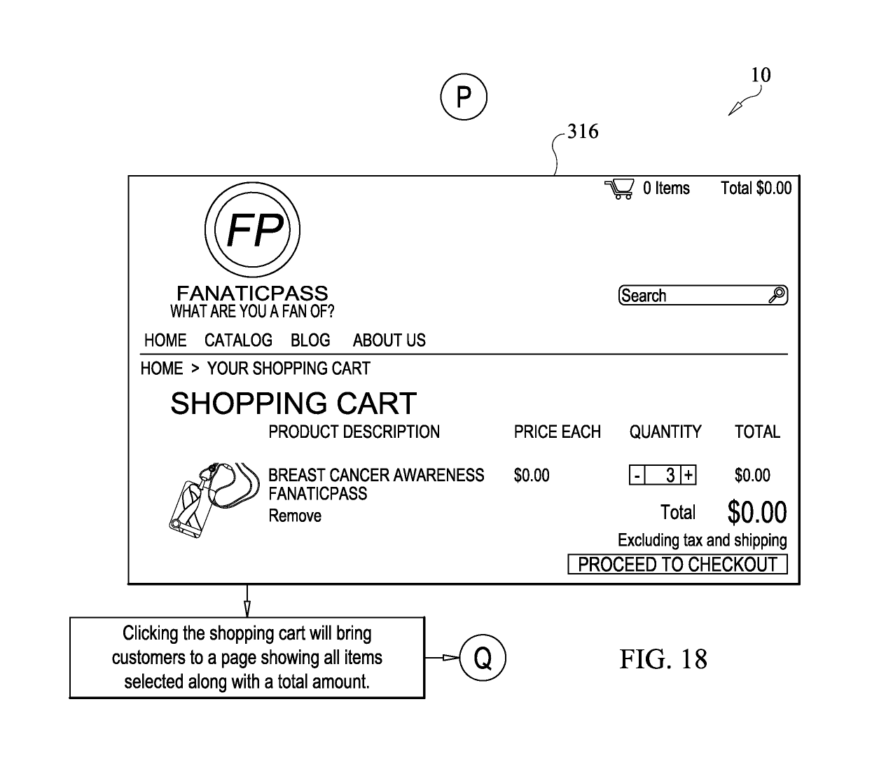

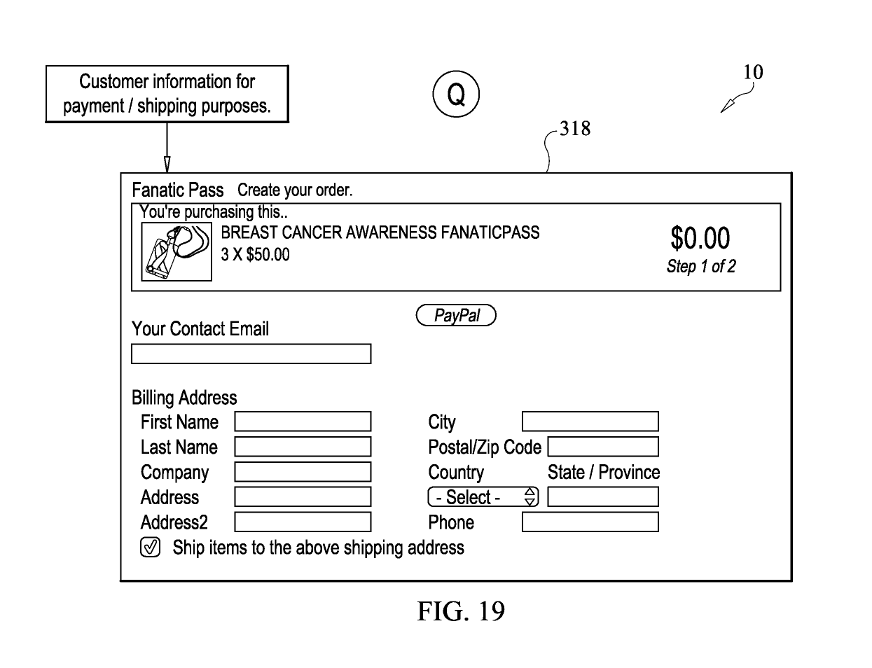

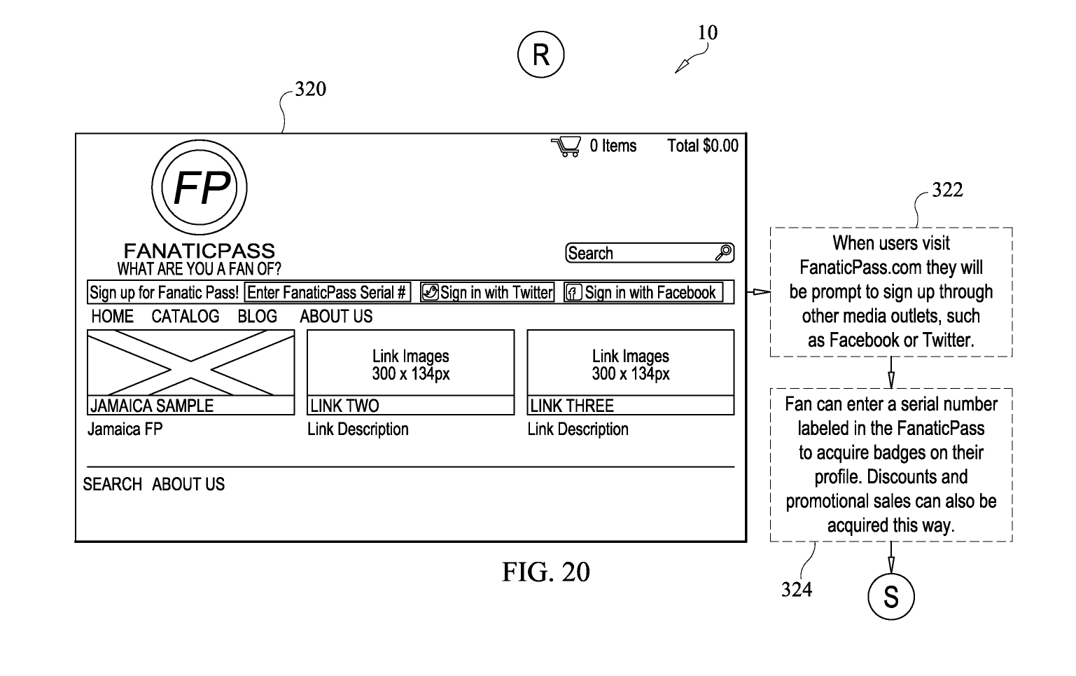

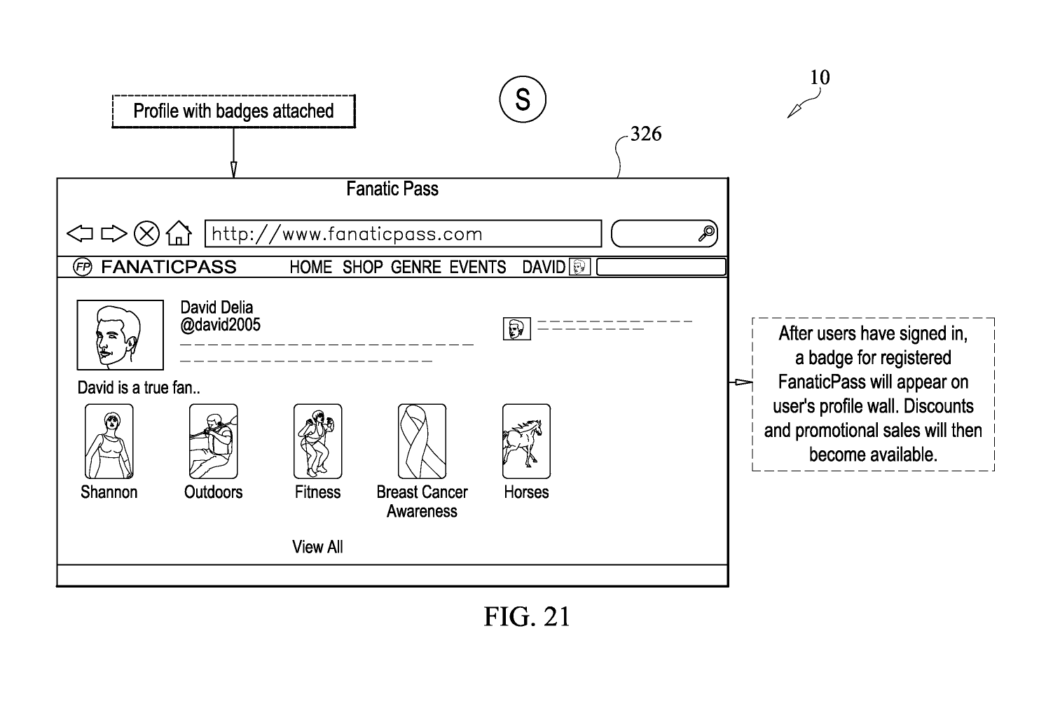

With reference to FIGS. 12-21, the set of processor readable code and screen displays 300-326 for the Fanatic Pass™ host and the host website and features are shown. Referring to FIG. 12, an example of the Fanatic Pass™ store front home page 302 is shown (300). The home page 302 will feature updated and primary information such as the latest passes 12 being offered and, or images of recent events. With reference to FIGS. 13 and 16, an example of a host catalog page 304 is shown. The catalog page 304 provides a catalog of genre passes 12 available for sale. A customer/fan can choose a pass 12 by clicking the desired pass 12 on the page. When clicking the desired pass image, the fan/customer is directed to a descriptive page comprising information related to the genre, as shown in FIG. 17. For instance, if the genre is a breast cancer foundation, the customer will view a descriptive dialog 314 of the product featuring different camera angles. The customer/fan can choose the desired quantity for purchase, continue shopping or advance to check-out by clicking the shopping cart icon, as shown in FIG. 18. With reference to FIG. 19, the system 10 and website comprises a fan/customer information page 318 for payment and shipping information. Referring to FIG. 14, an example of a host blog page 310 is shown. An example of a host “About Us” page 312 is shown in FIG. 15, which provides information regarding the host, e.g. Fanatic Pass™, and provides contact information or facilitates contact via e mail. With reference to FIG. 20, the website includes an active page for signing up with various social media outlets. When the fan/customer visits this page they will be prompted to sign up with various media outlets, such as Facebook®, Twitter® and, or Instagram® (322). The software 100 and system 10 of the instant invention can assign a customer specific serial number that allows a fan/customer to enter the serial number to acquire and load badges to their profile and to receive discounts and promotional sales (324). This serial number would be displayed on the pass 12. With reference to FIG. 21, the website will also include a profile page 326. The profile page 326 will display all the passes 12 that a fan/customer has purchased. After a fan/customer has signed in, the fan's badge(s) 12 will appear on the fan's profile wall 326. Discounts and promotional sales will then be made available.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A genre entity promotion system for promoting organizations of interests, such as sports, teams, bands and social causes, said system comprising:
a substrate having indicia identifying a genre entity and a scannable code on said substrate associated with said genre entity;
a host website accessible through a computer network, said host website comprising: a set of processor readable code for navigating through said host website;
at least one link to a social media page;
a plurality of genre entity substrates representing different genre entities; and
at least one link to a website associated with said genre entity;
said scannable code providing access to said host website.

2. A system as recited in claim 1, further comprising:
a set of genre entity readable code for processing data related to a genre entity.

3. A system as recited in claim 2, wherein said set of genre entity readable code comprises a link a URL address related to said genre entity.

4. A system as recited in claim 1, further comprising:
a set of registrant readable code accessible from said host website for obtaining data related to registrants.

5. A system as recited in claim 1, further comprising:
a set of processor readable code for linking to a plurality of different URL addresses.

6. A system as recited in claim 1, further comprising:
a lanyard for supporting said substrate.

7. A genre entity promotion system for promoting organizations of interests, such as sports, teams, bands and social causes, said system comprising:
a substrate having indicia identifying a genre entity and a scannable code on said substrate associated with said genre entity;
a host website accessible through a computer network, said host website comprising: a set of processor readable code for navigating through said host website;
at least one link to a social media page;
a plurality of genre entity substrates representing different genre entities; and
at least one link to a website associated with said genre entity;
said scannable code providing access to said host website; and
a set of genre entity readable code for processing data related to a genre entity.

8. A system as recited in claim 7, wherein said set of genre entity readable code comprises a link a URL address related to said genre entity.

9. A system as recited in claim 7, further comprising:
a set of registrant readable code accessible from said host website for obtaining data related to registrants.

10. A system as recited in claim 7, further comprising:
a set of processor readable code for linking to a plurality of different URL addresses.

11. A system as recited in claim 1, further comprising:
a lanyard for supporting said substrate.

12. A genre entity promotion system for promoting organizations of interests, such as sports, teams, bands and social causes, said system comprising:
a substrate having indicia identifying a genre entity and a scannable code on said substrate associated with said genre entity;
a host website accessible through a computer network, said host website comprising: a set of processor readable code for navigating through said host website;
at least one link to a social media page;
a plurality of genre entity substrates representing different genre entities; and
at least one link to a website associated with said genre entity;
said scannable code providing access to said host website; and
a set of registrant readable code accessible from said host website for obtaining data related to registrants.

13. A system as recited in claim 12, further comprising:
a set of genre entity readable code for processing data related to a genre entity.

14. A system as recited in claim 13, wherein said set of genre entity readable code comprises a link a URL address related to said genre entity.

15. A system as recited in claim 1, further comprising:
a set of processor readable code for linking to a plurality of different URL addresses.

16. A system as recited in claim 12, further comprising:
a lanyard for supporting said substrate.
